(19) United States
(12) Patent Application Publication
(10) Pub. No.: US 2012/0167863 A1
(43) Pub. Date: Jul. 5, 2012

(54) ENGINE SYSTEM AND METHOD WITH AIRFOIL FOR EGR INTRODUCTION

(76) Inventor: Sachin Shivajirao Kulkarni, Bengaluru (IN)

(21) Appl. No.: 12/980,787

(22) Filed: Dec. 29, 2010

(51) Int. Cl. F02M 25/07

(52) U.S. Cl. 123/568.17

(57) ABSTRACT

Methods and systems are provided for an engine. In one example, the engine system includes an intake conduit, and an airfoil suspended in the intake conduit via an exhaust gas recirculation passage, the exhaust gas recirculation passage fluidically coupled to an interior of the airfoil, the airfoil having a surface including a plurality of apertures fluidically coupling the interior of the airfoil with the intake conduit.

### FIELD

The subject matter disclosed herein relates to systems and methods for mixing exhaust gas in an air intake of an engine.

### BACKGROUND

Internal combustion engines may utilize an exhaust gas recirculation (EGR) system in order to reduce regulated emissions such as nitrogen oxides (NOₓ). For example, the exhaust gas directed to an intake passage of the engine through the EGR system may displace fresh air in combustion chambers of the engine to reduce peak combustion temperatures, thereby reducing NOₓ emissions.

Exhaust gas that enters the intake passage may not be completely mixed with intake air before the mixture of exhaust gas and intake air enters cylinders of the engine for combustion, however. Further, a backpressure may be generated in an exhaust passage when EGR is directed to the intake passage. As a result, a cylinder to cylinder distribution of exhaust gas may vary resulting in a NOₓ variation from cylinder to cylinder as well as increased fuel consumption, incomplete combustion, and torque imbalances.

### BRIEF DESCRIPTION

In one embodiment, an engine system is disclosed. The engine system comprises, an intake conduit, and an airfoil suspended in the intake conduit via an exhaust gas recirculation passage, the exhaust gas recirculation passage fluidically coupled to an interior of the airfoil, the airfoil having a surface including a plurality of apertures fluidically coupling the interior of the airfoil with the intake conduit.

In one aspect of this embodiment, by suspending the airfoil in the intake conduit, intake air can flow over the circumference of the airfoil thereby generating a lower pressure zone around the circumference of the airfoil. Due to the lower pressure zone, additional exhaust gas is drawn out of the apertures of the airfoil and into the intake manifold thereby reducing the back pressure in the exhaust passage. Further, because the airfoil has a plurality of apertures, mixing of exhaust gas and intake air may be improved resulting in a more homogeneous mixture of exhaust gas and intake air and improved cylinder-to-cylinder exhaust gas distribution. In this manner, one or more of NOₓ emissions, fuel consumption, incomplete combustion, and torque imbalances may be reduced.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present invention will be better understood from reading the following description of non-limiting embodiments, with reference to the attached drawings, wherein below:

FIG. 1 shows a schematic diagram of an example embodiment of a rail-vehicle with an engine system that includes an airfoil.

FIG. 2 shows a schematic diagram of an example embodiment of an airfoil suspended in an intake conduit.

FIG. 3 shows a cross-sectional view of the airfoil taken along line III-III shown in FIG. 2.

FIG. 4 shows a cross-sectional view of the airfoil taken along line IV-IV shown in FIG. 2.

FIG. 5 shows a cross-sectional view of an airfoil with angled apertures.

FIG. 6 shows a schematic diagram of an example embodiment of an annular airfoil suspended in an intake conduit.

FIG. 7 shows a cross-sectional view of the annular airfoil taken along line VII-VII shown in FIG. 6.

FIG. 8 shows a flow chart illustrating an example embodiment of a control routine for an engine system that includes an exhaust gas recirculation system and an airfoil.

FIG. 9 shows a cross-sectional view of an airfoil with a port.

### DETAILED DESCRIPTION

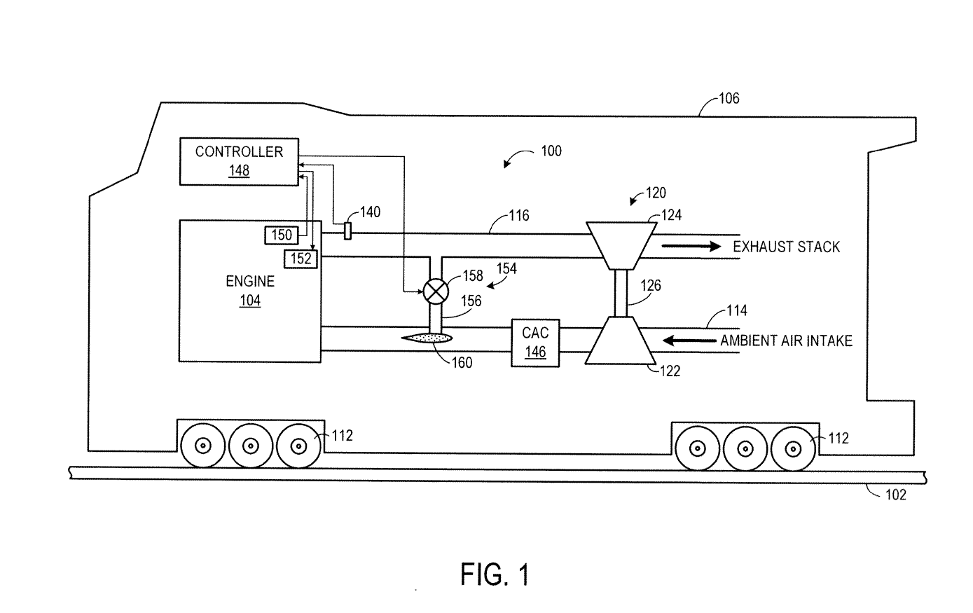

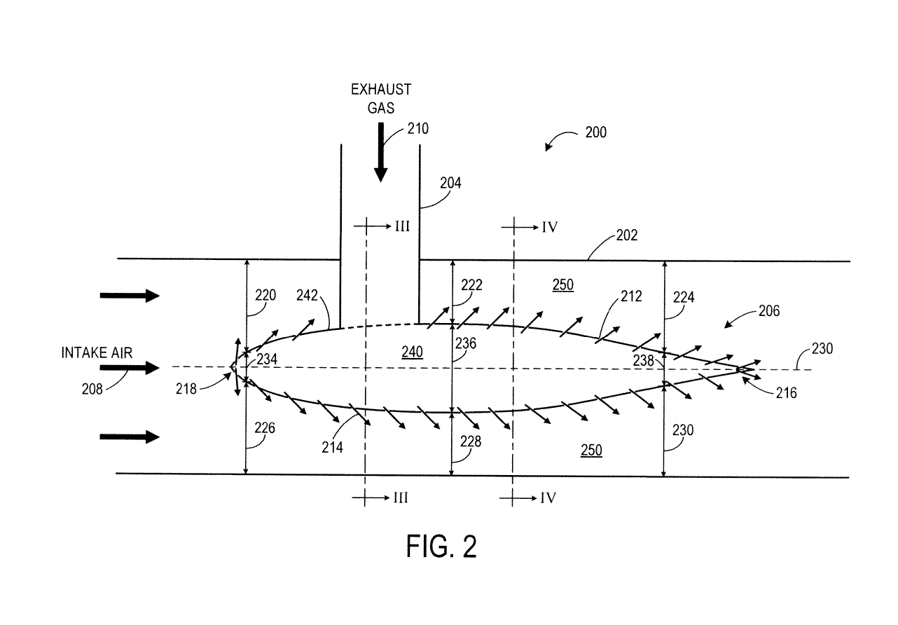

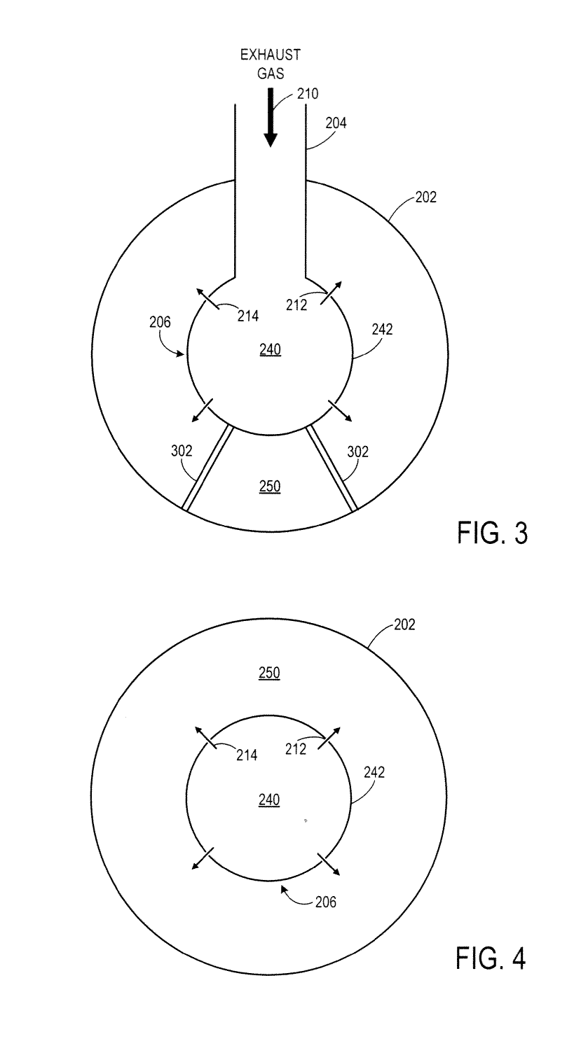

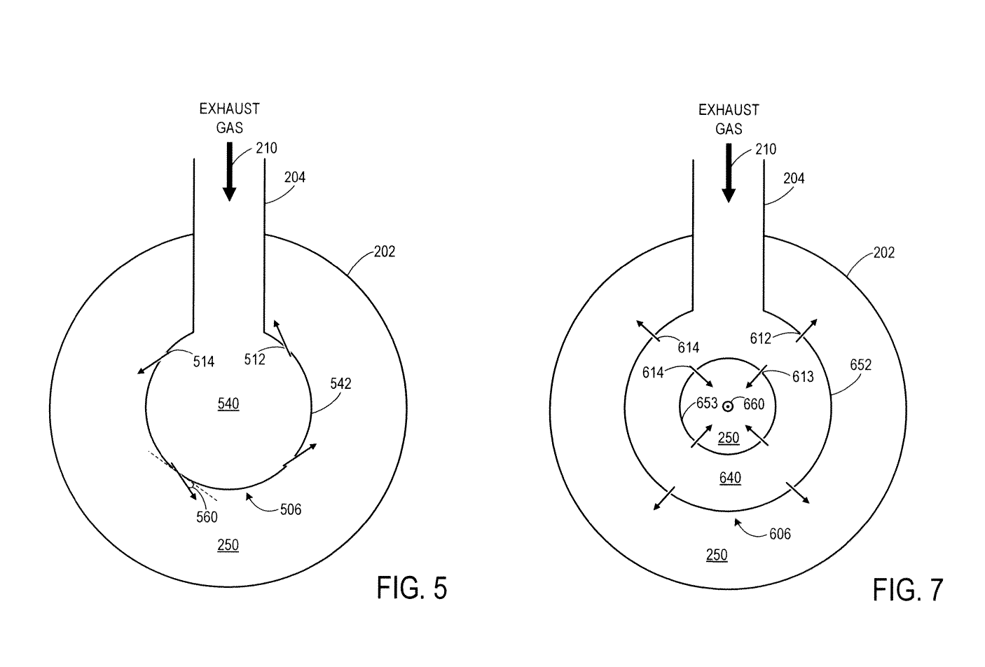

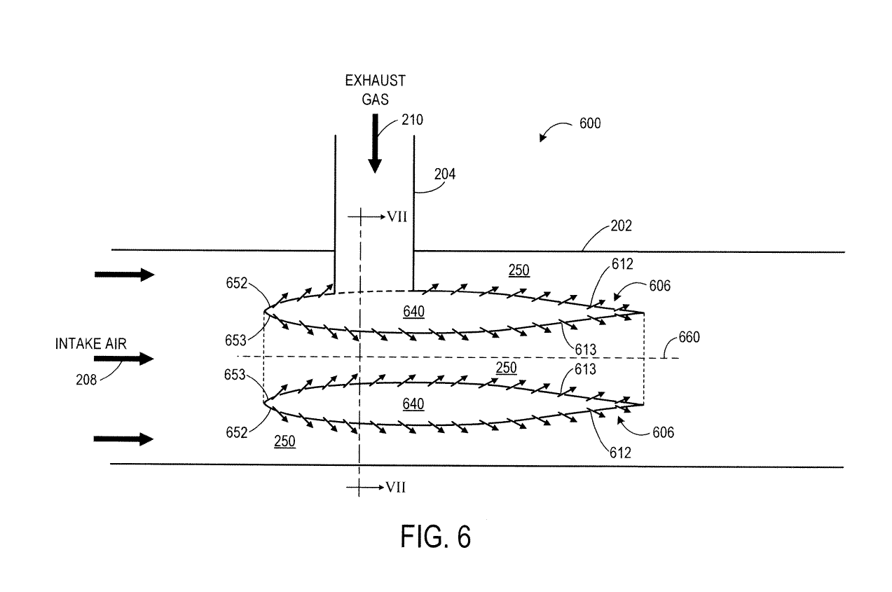

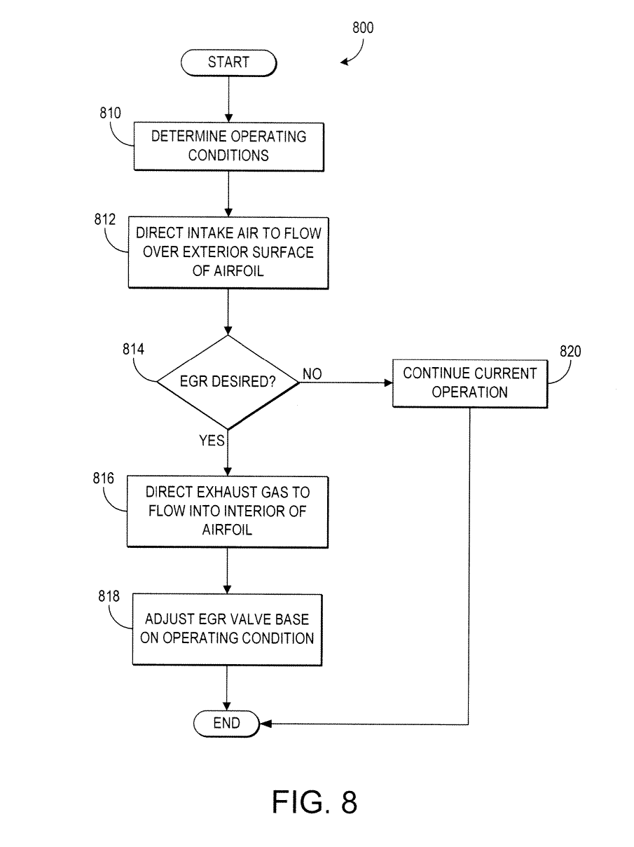

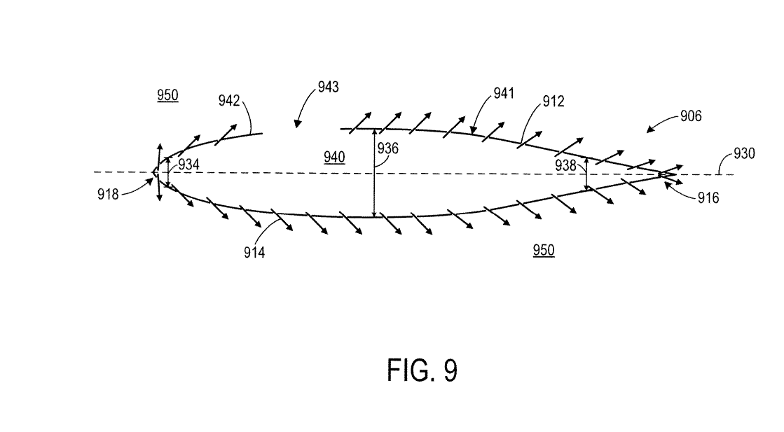

The following description relates to various embodiments of an engine system that includes an airfoil for EGR introduction into an engine intake. In one embodiment, the airfoil is physically and fluidically coupled to an exhaust gas recirculation (EGR) pipe that is part of an exhaust gas recirculation system and extends into an intake manifold. FIG. 1 shows an example in which the engine system is included in a rail vehicle. Details of an example airfoil included in the engine system are described with reference to FIGS. 2-4. For example, FIG. 2 shows a side of view of the airfoil in an intake conduit, FIG. 3 shows a cross-sectional view of the airfoil illustrating the physical and fluid coupling between the EGR pipe and the airfoil, and FIG. 4 shows a cross-sectional view illustrating the flow of intake air around the entire circumference of the airfoil. In some embodiments, the airfoil may have angled apertures, as shown in FIG. 5, which create a swirling motion in the gas exiting the airfoil. Further, FIGS. 6 and 7 show an example embodiment of an annular airfoil. An example method for directing exhaust gas through the EGR system and into the airfoil is described with reference to FIG. 8. Further, FIG. 9 shows an example embodiment of an airfoil which includes a port and where the airfoil is not coupled to an intake conduit.

FIG. 1 is a block diagram of an example embodiment of a vehicle system, herein depicted as a rail vehicle 106 (such as a locomotive), configured to run on a rail 102 via a plurality of wheels 112. The rail vehicle 106 includes an engine system 100 with an engine 104. However, in other examples, engine 104 may be a stationary engine, such as in a power-plant application, or an engine in a ship propulsion system.

The engine 104 receives intake air for combustion from an intake conduit 114. The intake conduit 114 receives ambient air from an air filter (not shown) that filters air from outside of the rail vehicle 106. Exhaust gas resulting from combustion in the engine 104 is supplied to an exhaust passage 116. Exhaust gas flows through the exhaust passage 116, and out of an exhaust stack (not shown) of the rail vehicle 106. In one example, the engine 104 is a diesel engine that combusts air and diesel fuel through compression ignition. In other non-limiting embodiments, the engine 104 may combust fuel including gasoline, kerosene, biodiesel, or other petroleum distillates of similar density through compression ignition (and/or spark ignition).

The engine system 100 includes a turbocharger 120 that is arranged between the intake conduit 114 and the exhaust passage 116. The turbocharger 120 increases air charge of ambient air drawn into the intake conduit 114 in order to provide greater charge density during combustion to increase power output and/or engine-operating efficiency. The turbocharger 120 includes a compressor 122 arranged along the intake conduit 114. The compressor 122 is at least partially driven by a turbine 124 (e.g., through a shaft 126) that is arranged in the exhaust passage 116. While in this case a single turbocharger is shown, the system may include multiple turbine and/or compressor stages. Further, the engine system 100 includes a charge air cooler (CAC) 146 arranged in the intake conduit 114 downstream of the compressor 122. The CAC 146 cools the air charge of ambient air after it passes through the turbocharger 120 in order to further increase the intake air charge density thereby further increasing the engine operating efficiency.

The engine system 100 further includes an exhaust gas recirculation (EGR) system 154. EGR system 154 includes an EGR pipe 156 and an EGR valve 158 for controlling an amount of exhaust gas that is recirculated from the exhaust passage 116 of engine 104 to the intake conduit 114 of engine 104. By introducing exhaust gas to the combustion chambers (not shown) of the engine 104, the amount of available oxygen for combustion is decreased, thereby reducing the combustion flame temperatures and reducing the formation of nitrogen oxides (e.g., NOₓ). The EGR valve 158 may be an on/off valve controlled by the controller 148, or it may control a variable amount of EGR, for example, as will be described in greater detail below. In some examples, the EGR system 154 may further include an EGR cooler to reduce the temperature of the exhaust gas before it enters the intake conduit 114. As shown in the example embodiment of FIG. 1, the EGR system 154 is a high-pressure EGR system. In other embodiments, the engine system 100 may additionally or alternatively include a low-pressure EGR system, routing EGR from downstream of the turbine to upstream of the compressor.

Further, the EGR system 154 depicted in the example embodiment of FIG. 1 includes a single EGR pipe 156 extending into the interior of the intake conduit 114. In other embodiments, the EGR system 154 may include more than one EGR pipe extending into the interior of the intake conduit 114. Exhaust gas is directed through the EGR pipe 156 to the interior of an airfoil 160. The airfoil 160 operates with incoming intake air to generate lower intake air pressure to draw exhaust gas from the EGR pipe 156 into the intake conduit 114, before delivering mixed intake gases (e.g., ambient air) and exhaust gas to engine 104. Further details of the airfoil 160 will be described in below with reference to FIGS. 2-4.

The rail vehicle 106 further includes a controller 148 to control various components related to the engine system 100. In one example, the controller 148 includes a computer control system. The controller 148 further includes computer readable storage media (not shown) including code for enabling on-board monitoring and control of rail vehicle operation. The controller 148, while overseeing control and management of the engine system 100, may be configured to receive signals from a variety of engine sensors 150, as further elaborated herein, in order to determine operating parameters and operating conditions, and correspondingly adjust various engine actuators 152 to control operation of the rail vehicle 106.

For example, the controller 148 receives a signal from exhaust gas sensor 140 indicating a concentration of one or more exhaust gas constituents (e.g., O₂, CO₂, NOₓ, or the like) in the exhaust gas flow from the engine. In one example, the controller 148 adjusts EGR valve 158 to open or close based on a concentration of NOₓ in the exhaust gas. For example, if the concentration of NOₓ is higher than desired, the controller 148 may adjust the EGR valve 158 to be open so that a desired amount of exhaust gas is directed to the intake conduit 114 in order to reduce the formation of NOₓ during combustion. As another example, the controller 148 may adjust one or more of valve timing, fuel injection timing, and fuel injection amount based on a concentration of oxygen in the exhaust gas (e.g., air fuel ratio) indicated by exhaust gas sensor 140. In this way, emissions of the rail vehicle 106 may be reduced, for example.

Furthermore, the controller 148 may receive signals from various engine sensors 150 including, but not limited to, engine speed, engine load, boost pressure, exhaust pressure, ambient pressure, etc. Correspondingly, the controller 148 may control the engine system 100 by sending commands to various components such as traction motors, alternator, cylinder valves, throttle, etc.

FIGS. 2-4 show schematic diagrams of an example embodiment of an engine intake system 200 which includes an airfoil 206 in an intake conduit 202, such as airfoil 160 described above with reference to FIG. 1. As shown in the example embodiments of FIGS. 2-4, the airfoil 206 is suspended in the intake conduit 202. In this example, the airfoil is suspended from, and supported by, EGR pipe 204. As used herein, “suspended” includes the airfoil being spaced away from the walls of the intake conduit.

In the particular example shown in FIG. 2, the airfoil is not coupled to the walls of the intake conduit, but is distinct from the walls, and only physically coupled to the EGR pipe 204. As such, in this example, the EGR pipe 204 provides structural support for the airfoil 206, thus reducing manufacturing and/or installation costs. In some embodiments, such as shown in FIG. 3, structural support for the airfoil can be provided additionally or alternatively from the intake conduit. For example, in FIG. 3, two supports 302 extend from the wall of the intake conduit to support the airfoil 206 in addition to the support provided by the EGR pipe 204. The supports 302 may be made of a material such as metal, for example, that is resistant to deformation in the intake conduit and that can support the weight of the airfoil 206. Further, it should be understood that two supports 302 are shown as an example in FIG. 2, and the location and number of supports may be adjusted, if desired. In an embodiment, the airfoil is suspended in the intake conduit from a support connected to the intake conduit. In another embodiment, the support comprises the EGR pipe 204. In another embodiment, the support additionally or alternatively comprises one or more other types of supports, such as supports 302 shown in FIG. 3.

As shown in the example embodiments of FIGS. 2-4, a top portion of the airfoil 206 is suspended in the intake conduit 202 and physically and fluidically coupled to an EGR pipe 204. The physical connection includes the structural coupling of the airfoil to the conduit, while the fluidic coupling includes a fluidic path from the interior of the EGR pipe 204 to the interior of the airfoil 206 such that EGR (e.g., recirculated exhaust gas) can flow from the EGR pipe 204 to the interior 240 of the airfoil 206. In some embodiments the airfoil 206 may be bolted to the EGR pipe 204. In other embodiments, the airfoil 206 may be welded to the EGR pipe 204. In still other embodiments, the airfoil 206 may be connected to the EGR pipe 204 by a flange. It should be understood, the airfoil 206 may be attached to EGR pipe 204 and/or to the intake conduit 202 in any suitable manner.

FIG. 3, which is a cross-sectional view of the airfoil 206 taken along line III-III of FIG. 2, shows how the airfoil 206 is coupled to the EGR pipe 204 and suspended in the intake conduit 202. As shown in FIG. 3, exhaust gas 210 flows through the EGR pipe 204 and into the interior 240 of the airfoil 206. Further, intake gases flow around the EGR pipe 204 and around the exterior surface 242 of the airfoil 206.

The airfoil 206 may be made of metal, for example, or another material which is resistant to deformation under the fluctuation of pressure in the intake conduit 202. In some examples, the airfoil 206 may be made of the same material as the EGR pipe 204, and integral with EGR pipe 204, for example.

FIGS. 2-4 show embodiments in which the intake conduit 202 includes a single airfoil 206 coupled to the EGR pipe 204. In other embodiments, more than one airfoil may be coupled in the intake conduit. For example, if the engine system includes a high-pressure EGR system and a low-pressure EGR system, the EGR pipe corresponding to each EGR system may have an airfoil coupled to its end extending into the intake conduit. In other examples, more than one high-pressure EGR pipe and/or more than one low-pressure EGR pipe may extend into the intake conduit and an airfoil may be coupled to each EGR pipe extending into the intake conduit.

A leading edge 218 of the airfoil 206 faces upstream in the intake conduit 202 and a trailing edge 216 of the airfoil faces downstream in the intake conduit 202. As such, the leading edge 218 of the airfoil 206 faces into the intake air 208 flowing through the intake conduit 202. As illustrated in FIG. 2, the leading edge 218 of the airfoil 206 has a more rounded shape, while the trailing edge 216 of the airfoil 206 gradually tapers to a point. Further, as shown in the example embodiment of FIG. 2, the airfoil 206 is a symmetric airfoil with an angle of attack of zero degrees, and the airfoil 206 is symmetric about line 230 (e.g., the mean camber line of the airfoil) in FIG. 2. As used herein, “symmetric” implies the distance between the mean camber line of the airfoil (e.g., line 230) and the top of the airfoil and the distance between the mean camber line of the airfoil and the bottom of the airfoil are equal at each point along the mean camber line. In this way, as the intake air 208 flows over the airfoil 206, a lower pressure zone is generated around the circumference of the exterior surface 242 of the airfoil 206 thereby drawing exhaust gas out of the airfoil 206 and into the intake conduit 202 when the EGR valve is open. For example, the pressure around the airfoil 206 is lower than the intake air pressure upstream and/or downstream of the airfoil 206. As such, the lower pressure zone generated around the exterior surface 242 of the airfoil 206 reduces back pressure on the exhaust passage by reducing flow resistance in the intake conduit when the EGR valve is open, for example, thereby reducing flow loses and fuel consumption. In other embodiments, the airfoil may have an angle of attack that is less than or greater than zero degrees and/or the airfoil may be an asymmetric airfoil, for example.

Further, a cross-section in at least one region of the airfoil 206 has a rounded shape in at least one portion. Further still, the entire cross-section may be round (e.g., circularly or elliptically shaped). As one example, in FIG. 4, which shows a cross-section of the airfoil 206 taken along line IV-IV of FIG. 2, the airfoil 206 has a round cross-section. In some embodiments, the airfoil 206 may have an elliptical shape that has an eccentricity that varies between 0 and 1 (e.g., 0≦ε<1) along the length of the airfoil. For example, the airfoil 206 may have a round cross section (e.g., ε=0) in one region and the airfoil 206 may have a more elongated cross-section in another region. In other embodiments, the airfoil 206 may have substantially the same cross-sectional shape along the entire length of the airfoil 206. For example, every cross-section along the length of the airfoil 206 may have a round shape.

Further, the cross-sectional area of the airfoil 206 may increase from the leading edge 218 toward a middle of the airfoil 206 and then decrease toward the trailing edge 216 of the airfoil 206, as illustrated in FIG. 2. For example, a first cross-section of the airfoil 206 is taken along line 234 of FIG. 2, which may be a diameter of the first cross-section if the cross-sectional shape is round, near the leading edge of the airfoil. A second cross-section of the airfoil 206 is taken along line 236 of FIG. 2, which may be a diameter of the second cross-section if the cross-sectional shape is round. As shown, the second cross-section is further from the leading edge 218 of the airfoil 206 than the first cross-section, and the length of line 236 is greater than that of line 234. Thus, at least in the case in which the airfoil 206 has a round cross-section at both locations, the area of the first-cross section is less than that of the second cross-section. A third cross-section of the airfoil 206 is taken along a line 238 of FIG. 2, which may be a diameter of the third cross-section if the cross-sectional shape is round. The third cross-section is closer to the trailing edge of the airfoil 206 than the second cross-section. Because line 238 is shorter than line 236, at least in the case in which the airfoil has a round cross-section at both locations, the area of the second cross-section is greater than that of the third cross-section.

Accordingly, the flow area of intake gases changes based on the shape of the airfoil 206. In one example, and as shown in FIG. 2, the flow area around the exterior surface 242 of the airfoil 206 is smaller in the vicinity of the second cross-sectional area than in the vicinity of the first and third cross-sectional areas. For example, the length of line 222 is greater than that of lines 220 and 224, indicating a smaller distance between the airfoil 206 and the interior wall of intake conduit 202 at the second cross-section than at the first and third cross-sections; therefore, a smaller flow passage exists at the second cross-section. Furthermore, the airfoil 206 may be positioned in the intake conduit 202 such that it is in the center of the intake conduit and both the airfoil 206 and the intake conduit 202 are symmetric about line 230. FIG. 2 shows an example of such a configuration; thus, lines 220 and 226 are substantially equal, lines 222 and 228 are substantially equal, and lines 224 and 230 are substantially equal. In other embodiments, the airfoil 206 may be positioned such that its mean camber line is spaced away from the center of the intake conduit 202 (e.g., line 222 is greater than or less than line 228).

The airfoil 206 further includes a plurality of apertures 212 on its exterior surface 242 fluidically coupling the interior 240 of the airfoil 206 with the interior region 250 of the intake conduit 202. The apertures 212 may have any suitable shape, for example, circular, elliptical, etc. Further, the plurality of apertures 212 may have mixed shapes, for example, some of the apertures may be circular and other apertures may be elliptical. When the EGR valve is open (and exhaust gas can enter the interior 240 of the airfoil 206), exhaust gas 214 flows radially out of the apertures 212 due to the area of lower pressure generated by the flow of intake gases around the exterior surface 242 of the airfoil 206 drawing exhaust gas out of the interior 240 of the airfoil 206 and into the interior 250 of the intake conduit 202. As shown in FIGS. 2-4, the plurality of apertures 212 are positioned along the longitudinal axis of the airfoil 206 (meaning there are different apertures at spaced apart locations with respect to a direction of the axis) as well as around a circumference of the airfoil 206 at varying distances from a center of the airfoil 206. The size and distribution of apertures 212 around the exterior surface 242 of the airfoil 206 is such that the homogeneity of the mixture of intake gases and exhaust gas is increased, for example. In some embodiments, the total area of the plurality of apertures 212 may be substantially equal to the cross-sectional area of the EGR pipe 204.

In some embodiments, the apertures 212 may extend radially from the center of the airfoil 206 to the outer boundaries of the airfoil. Thus, exhaust gas may be added to the intake air across a substantial portion of the cross-section of intake conduit 202 including areas of the cross-section where a velocity of the airflow may be higher than other areas (e.g., higher velocity airflow near the center of the intake conduit than the edges), resulting in increased mixing of exhaust gas and intake air. By introducing a homogenous mixture of intake air and exhaust gas to the cylinders of the engine, the cylinder to cylinder distribution of exhaust gas may be improved thereby reducing the NOₓ variation from cylinder to cylinder as well as reducing the fuel consumption.

Further, it should be noted, in the example embodiment depicted in FIGS. 2-4, the apertures 212 are radial apertures. As used herein, “radial apertures” implies the walls of the apertures formed by a thickness (e.g., a distance between the outer surface of the airfoil and the inner surface of the airfoil) of the airfoil are substantially orthogonal to the outer surface of the airfoil and exhaust gas flows radially out of the apertures. In other embodiments, the apertures may be angled apertures, for example, FIG. 5 shows example embodiment in which the airfoil 506 has angled apertures 512. In such an embodiment, exhaust gas flows from the interior 540 of the airfoil 506 at an angle to the outer surface 542 of the airfoil 506. As used herein, “angled apertures” implies the walls of the apertures formed by a thickness of the airfoil are at an angle with respect to the outer surface of the airfoil and exhaust gas flows out of the apertures at an angle to the outer surface of the airfoil. The angle of the apertures may be in the range between 0 and 90 degrees with respect to the outer surface of the airfoil. In one specific example, the angle may be between 25 and 80 degrees, such as 45 degrees, 60 degrees, etc. The specific example of FIG. 5 shows an angle 560 of approximately 30 degrees. The plurality of angled apertures 512 induces a swirling motion of the exhaust gas 514 flowing from the plurality of apertures 512 thereby further enhancing the mixing of the exhaust gas and the intake air before the mixture enters the cylinders of the engine. Further, the angle of the apertures may vary along the direction of the intake air flow from the leading edge to the trailing edge of the airfoil. Further still, the angle may also be between 90 and 180 degrees to provide reverse swirl. For example, counter-clockwise motion may be generated by a plurality of angled apertures in an upstream portion (e.g., at line III-III) with an angle of 30 degrees as illustrated in FIG. 5, while clockwise motion may be generated by a plurality of oppositely angled apertures (e.g., 150 degrees) in a downstream portion (e.g., at line IV-IV). Further yet, a random distribution of angles along the length and radially around the airfoil may be used, if desired.

In still other embodiments, the outer surface 242 (or 542) of the airfoil 206 (or 506) may include one or more features to increase turbulence that enhances the mixing of exhaust gas and intake air. For example, the outer surface of the airfoil may include specially designed projections, dimples, baffles, etc. in areas between the apertures that generate turbulence downstream of the airfoil.

Thus, FIGS. 2-5 show example embodiments of an airfoil 206 coupled in an intake conduit 202 via an EGR pipe 204. The lower pressure, as compared to intake pressure upstream and/or downstream of the airfoil 206, generated around the airfoil 206 by the flow of intake gases around the circumference of the airfoil 206, draws exhaust gas out through a plurality of apertures 212 in the exterior surface 242 of the airfoil 206. In this manner, a back pressure on the exhaust passage may be reduced and the exhaust gas may be mixed more homogeneously with the intake gases. As a result, one or more of pumping loses, fuel consumption, incomplete combustion, torque imbalances, and NOₓ variation from cylinder to cylinder may be reduced, for example.

Continuing to FIGS. 6 and 7, schematic diagrams of an example embodiment of an annular airfoil 606 suspended in an intake conduit 202 via an EGR pipe 204 are shown. FIG. 7 shows a cross-sectional view of the airfoil 606 depicted in FIG. 6 taken through the line VII-VII. Parts that are the same in FIGS. 6 and 7 as those in FIGS. 2-5 are given the same reference numbers. As shown in FIGS. 6 and 7, the annular airfoil 606 forms a ring shape, and is symmetric about its longitudinal axis 660. Due to the annular shape (e.g., ring shape) of the airfoil in a direction perpendicular to the flow of intake air 208, intake air 208 flows over an outer surface 652 of the airfoil 606 as well as over an inner surface 653 of the airfoil 606. As such, lower pressure zones (e.g., lower than an area upstream and/or downstream of the airfoil) are generated around an outer and inner circumference of the airfoil 606.

Further, the annular airfoil 606 includes apertures 612 along the longitudinal axis 660 of the annular airfoil 606 as well as along the inner and outer circumference of the annular airfoil 606. It should be understood, the apertures 612 may have any suitable combination of size, shape (e.g., circular, elliptical), and distribution, as described above. Further, the apertures may be radial or angled apertures, or any suitable combination of radial and angled apertures. Thus, exhaust gas 210 that flows through the EGR system and into the airfoil 606 is drawn out of the interior 640 of the annular airfoil 606 through the apertures 612 on the outer surface 652 and inner surface 653 of the annular airfoil 606 and into the interior 250 of the intake conduit 202 due to the low pressure zones created by the flow of intake air 208 over the annular airfoil 606. In such an embodiment, the homogeneity of the mixture of exhaust gas and intake air may be increased, for example.

Continuing to FIG. 8, it shows a flow chart illustrating a control routine 800 for an engine system with an exhaust gas recirculation system and an airfoil, such as engine system 100 described above with reference to FIG. 1, according to an embodiment of the invention. Specifically, routine 800 determines if EGR is desired and directs a desired amount of exhaust gas to the intake conduit accordingly.

At 810 of routine 800, engine-operating conditions are determined. For example, engine-operating conditions may include air-fuel ratio, combustion temperature, exhaust gas constituent concentrations, exhaust gas temperature, etc.

Once the engine operating conditions are determined, routine 800 proceeds to 812 where intake air is directed to flow over the exterior surface of the airfoil. For example, when the engine is running and a throttle is open, ambient air from the environment surround the vehicle flows into the intake conduit and over the exterior surface of the airfoil before entering combustion chambers of the engine.

At 814 of routine 800, it is determined if EGR is desired. EGR may be desired when the exhaust gas sensor indicates a concentration of NOₓ that is higher than desired or when a combustion temperature higher than desired, for example. EGR may not be desired when the combustion temperature is low (e.g., when the engine is cold), since NOₓ formation may be increased, for example.

If it is determined that EGR is not desired, routine 800 moves to 820 and current operation of the engine system is continued. On the other hand, if it is determined that EGR is desired, routine 800 continues to 816 where exhaust gas is directed to flow into the interior of the airfoil. For example, the controller may move the EGR valve from a closed position to an open position. In some examples, the valve opening may be adjustable such that an amount of exhaust gas that passes through the EGR valve can be controlled.

At 818 of routine 800, the EGR valve is adjusted based on an operating condition. As an example, the operating condition may be an amount of NOₓ in the exhaust gas as indicated by an exhaust gas sensor. As another example, the EGR valve may be adjusted based on amount of intake air flowing through the intake conduit (e.g., as indicated by a mass air flow sensor, for example) such that a desired ratio of intake air to exhaust gas is achieved.

Thus, the EGR valve may be controlled to direct a desired amount of exhaust gas to the intake conduit based on various operating parameters such as combustion temperature and NOₓ concentration in the exhaust gas. The exhaust gas may be directed to the interior of an airfoil and drawn out through a plurality of apertures due to a lower pressure area surrounding the airfoil, as described above. In this way, the homogeneity of the intake air and exhaust gas mixture may be improved resulting in one or more of a reduction pumping loses, fuel consumption, and NOₓ variation from cylinder to cylinder, for example.

With reference to FIG. 9, another example embodiment relates to an airfoil 906 for an engine system. The airfoil 906 comprises an airfoil body 941 defining an external surface 942 and a hollow interior 940. The airfoil body 941 includes a plurality of apertures 912 fluidically coupling the interior 940 of the airfoil with an exterior 950 of the airfoil body. The airfoil body 941 includes a port 943, extending from the exterior of the airfoil body to the interior, for fluidic coupling with an exhaust gas recirculation pipe or other exhaust gas recirculation conduit. That is, an exhaust gas recirculation pipe may be inserted into the port 943 for fluidically coupling the pipe with the interior 940 of the airfoil body 941, such as shown in FIGS. 2, 3, and 5-7. For example, the port 943 may include a boss such that an exhaust gas recirculation pipe may be coupled to the airfoil 906.

In another embodiment, the airfoil body has a rounded cross-section in at least one region. In another embodiment, the apertures 912 are positioned along a longitudinal axis of the airfoil body (indicated by line 930 in FIG. 9), as well as around a circumference of the airfoil body 941. The apertures may include radial apertures and/or angled apertures through which gases 914 may exit the interior 940 of the airfoil 906, as described above. As shown in the example embodiment of FIG. 9, the port 943 is a larger opening than the apertures 912. Furthermore, the port 943 is normal (e.g., radial) to the surface of the airfoil 906 while apertures 912 may be radial and/or angled.

In another embodiment, the plurality of apertures 912 are positioned between a leading edge and a trailing edge of the airfoil body along a longitudinal axis of the airfoil body, as well as around a circumference of the airfoil.

In another example embodiment, a first cross-sectional area (indicated at 934 in FIG. 9) of the airfoil body 941 is smaller than a second cross-sectional area (indicated at 936 in FIG. 9) of the airfoil body 941. The first cross-sectional area is closer to a leading edge 918 of the airfoil body than the second cross-sectional area. The second cross-sectional area is larger than a third cross-sectional area (indicated at 938 in FIG. 9). The third cross-sectional area is closer to a trailing edge 916 of the airfoil body 941 than the second cross-sectional area.

Further, in another embodiment, the airfoil body is symmetric and has an angle of attack of zero degrees.

In another example embodiment, the airfoil is annular, and the airfoil body includes an annular outer body portion and an annular inner body portion. The annular outer body portion has an annular leading edge and an annular trailing edge. The annular inner body portion likewise has an annular leading edge and an annular trailing edge. The inner body portion is nested within the outer body portion. The leading edges are coincident with one another, and the trailing edges are coincident with one another, such that the inner body portion and the outer body portion are attached to one another at the leading and trailing edges. The outer body portion defines an outer surface of the airfoil body. The inner body portion defines an inner surface of the airfoil body. In an embodiment, the inner body portion has a varying inner diameter, starting out at a first, larger diameter at the leading edge, constricting to a second, smaller diameter, and then expanding out to a third diameter, which is larger than the second diameter, at the trailing edge. A space between the inner body portion and the outer body portion defines a hollow, annular interior of the airfoil body. In such an embodiment, both the outer body portion and the inner body portion define apertures for fluidically coupling the hollow, annular interior with an exterior of the airfoil body. Further, in such an embodiment, the outer body portion defines the port.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. An engine system, comprising:
an intake conduit; and
an airfoil suspended in the intake conduit from a support connected to the intake conduit, wherein an exhaust gas recirculation passage of the engine system is fluidically coupled to an interior of the airfoil, the airfoil having a surface including a plurality of apertures fluidically coupling the interior of the airfoil with the intake conduit.

2. The engine system of claim 1, wherein the surface is an exterior surface of the airfoil, and wherein the exterior surface of the airfoil is spaced away from interior walls of the intake conduit to form a flow passage around the exterior surface of the airfoil and within the intake conduit.

3. The engine system of claim 1, wherein the airfoil has a rounded cross-section in at least one region.

4. The engine system of claim 3, wherein the plurality of apertures are positioned along a longitudinal axis of the airfoil, as well as around a circumference of the airfoil, and wherein the apertures are radial apertures.

5. The engine system of claim 1, wherein the airfoil is a symmetric airfoil with an angle of attack of zero degrees, and a leading edge of the airfoil faces upstream.

6. The engine system of claim 1, wherein a first cross-sectional area of the airfoil is smaller than a second cross-sectional area of the airfoil, and the first cross-sectional area is closer to a leading edge of the airfoil than the second cross-sectional area, and wherein the second cross-sectional area is larger than a third cross-sectional area, and the third cross-sectional area is closer to a trailing edge of the airfoil than the second cross-sectional area.

7. The engine system of claim 6, wherein a flow area of gasses around an exterior surface of the airfoil is smaller in a vicinity of the second cross-sectional area than in a vicinity of the first and third cross-sectional areas.

8. The engine system of claim 1, wherein the support comprises an exhaust gas recirculation pipe or other conduit defining the exhaust gas recirculation passage.

9. A method for an engine, comprising:
directing intake gasses to flow over an exterior surface of an airfoil with a plurality of apertures, the airfoil coupled within an intake conduit of the engine; and
directing exhaust gas from an exhaust passage to flow into an interior of the airfoil and then out of the airfoil through the plurality of apertures in the exterior surface of the airfoil to mix with the intake gasses.

10. The method of claim 9, wherein the intake gasses flow around an exhaust gas recirculation pipe that extends into an interior region of the intake conduit, the exhaust gas recirculation pipe fluidically coupled to the airfoil for directing the exhaust gas to flow into the interior of the airfoil.

11. The method of claim 10, wherein the exhaust gas flows from the exhaust passage into the interior of the airfoil through the exhaust gas recirculation pipe, and then flows from the interior of the airfoil, through the plurality of apertures, to mix with the intake gases.

12. The method of claim 10, further comprising adjusting an amount of exhaust gas flow via an exhaust gas recirculation valve coupled to the exhaust gas recirculation pipe upstream of the airfoil.

13. The method of claim 9, wherein the intake gases flow over an entire circumference of the exterior surface of the airfoil, the airfoil having an elliptical cross-section in at least one region.

14. The method of claim 9, wherein the intake gases flow through a compressor and a charge air cooler before flowing over the exterior surface of the airfoil, and wherein the intake gasses flow between the exterior surface of the airfoil and interior walls of the intake conduit.

15. The method of claim 9, wherein the exhaust gas flows radially outward from the plurality of apertures in the exterior surface of the airfoil, and the exhaust gas is drawn out from the interior of the airfoil by reduced pressure created by the intake gasses flowing over the exterior surface of the airfoil.

16. The method of claim 9, wherein the airfoil is an annular airfoil, and intake gases flow over an outer circumference and an inner circumference of the annual airfoil.

17. A system for an engine, comprising:
an intake conduit directing intake air along an intake air flow direction;
an exhaust passage coupled to the engine;
an exhaust gas recirculation pipe extending from the exhaust passage to the intake conduit; and
an airfoil, an interior of the airfoil fluidically coupled to an exit of the exhaust gas recirculation pipe, the airfoil comprising a plurality of apertures along the intake air flow direction, the plurality of apertures fluidically coupling the intake conduit with the interior of the airfoil.

18. The system of claim 17, further comprising: an exhaust gas recirculation valve coupled in the exhaust gas recirculation pipe; and a controller for adjusting the exhaust gas recirculation valve to direct exhaust gas to flow into the airfoil based on an operating condition.

19. The system of claim 17 wherein at least some of the apertures are angled with respect to an exterior surface of the airfoil.

20. The system of claim 17, wherein the airfoil is positioned downstream of a charge air cooler and a compressor of a turbocharger, and wherein the airfoil is suspended in the intake conduit by the exhaust gas recirculation pipe.

21. The system of claim 17, wherein the plurality of apertures are positioned between a leading edge and a trailing edge of the airfoil along a longitudinal axis of the airfoil, as well as around a circumference of the airfoil, and wherein the airfoil is symmetric and has an angle of attack of zero degrees, and wherein the apertures are angled apertures.

22. The system of claim 17, wherein a first cross-sectional area of the airfoil is smaller than a second cross-sectional area of the airfoil, and the first cross-sectional area is closer to a leading edge of the airfoil than the second cross-sectional area, and wherein the second cross-sectional area is larger than a third cross-sectional area, and the third cross-sectional area is closer to a trailing edge of the airfoil than the second cross-sectional area, and wherein, in at least one region, a cross-sectional area of the airfoil has round shape.

23. An airfoil for an engine system, the airfoil comprising:
an airfoil body defining an external surface and a hollow interior;
wherein the airfoil body includes a plurality of apertures fluidically coupling the interior of the airfoil with an exterior of the airfoil body; and
wherein the airfoil body includes a port, extending from the exterior of the airfoil body to the interior, for fluidic coupling with an exhaust gas recirculation pipe or other exhaust gas recirculation conduit.
